(19) United States
(12) Patent Application Publication
(10) Pub. No.: US 2006/0020937 A1
(43) Pub. Date: Jan. 26, 2006

(54) System and method for extraction and creation of application meta-information within a software application repository

(75) Inventor: Stuart Schaefer, Marblehead, MA (US)

Correspondence Address: WILMER CUTLER PICKERING HALE AND DORR LLP, 60 STATE STREET, BOSTON, MA, 02109, US

(73) Assignee: Softricity, Inc.

(21) Appl. No.: 11/186,630

(22) Filed: Jul. 21, 2005

Related U.S. Application Data
(60) Provisional application No. 60/589,614, filed on Jul. 21, 2004.

(51) Int. Cl. G06F 9/445

(52) U.S. Cl. 717/175; 717/174

(57) ABSTRACT

Methods for automating the detection and use of dependent software packages on a target machine include during the installation or execution of a first software package, detecting a dependency, pausing the installation or execution of the software package, configuring the dependent software package, and continuing the installation or execution of the first software package. The step of detecting the dependency includes the step of querying one or more repositories for the dependency. Further, the step of detecting the dependency includes the use of rules for template matching, or querying one or more repositories for matching configuration information. The step of detecting the dependency includes execution of a software operation on the target machine wherein a resultant failure indicates the need to query a repository. Information indicative of the configuration of the dependent software package is added to a preconfiguration snapshot of the target machine. The step of configuring the dependent software package on the target machine is performed by simulation or virtual installation. This step includes updating one or more repositories of the configuration and dependencies of the first software package. The method further includes updating one or more repositories of the configuration and dependencies of the first software package.

### CROSS-REFERENCE TO RELATED APPLICATIONS

This application claims priority to U.S. Provisional Patent Application No. 60/589,614, filed on Jul. 21, 2004, which is incorporated herein by reference.

### BACKGROUND

In systems of the current art, applications are typically treated as separate units or “packages.” Within many application execution environments, it is desirable to segregate applications to prevent systemic failures due to sociability problems. The management of applications across a diverse end user population or network has led to many different attempts to resolve this issue.

The teachings of U.S. Patent Application 60/598,234 entitled “System and Method for Controlling Inter-Application Association through Contextual Policy Control” are incorporated herein by reference.

### SUMMARY OF THE INVENTION

The present invention describes methods that integrate all software systems within a set of one or more repositories for automated configuration and version management.

In accordance with one aspect of the invention, a method for automating the detection and use of dependent software packages on a target machine includes during the installation or execution of a first software package, detecting a dependency; pausing the installation or execution of the software package; configuring the dependent software package; and continuing the installation or execution of the first software package. The step of detecting the dependency includes the step of querying one or more repositories for the dependency. Further, the step of detecting the dependency includes the use of rules for template matching, or querying one or more repositories for matching configuration information. The step of detecting the dependency includes execution of a software operation on the target machine wherein a resultant failure indicates the need to query a repository. The step of detecting the dependency also includes searching a set of configured assets of the first software package. The step of configuring the dependent software package on the target machine includes an installation of the dependent software package. Information indicative of the configuration of the dependent software package is added to a preconfiguration snapshot of the target machine. The step of configuring the dependent software package on the target machine is performed by simulation or virtual installation. This step includes updating one or more repositories of the configuration and dependencies of the first software package. The method further includes updating one or more repositories of the configuration and dependencies of the first software package.

In accordance with another aspect of the present invention, a method for automating the detection and use of dependent software packages on a target machine, includes searching a set of installation assets of a first software package for indication of dependency upon one or more other dependent software packages, and configuring the dependent software package. The step of searching comprises pattern matching of information contained within the installation assets. This step includes the use of code analysis methods.

Another aspect of the present invention includes, a system for creating a software repository that includes a software package asset store, a metadata store, and an integration engine. The system further includes a rule or templating engine for querying the contents of the package asset store, metadata store, and dependencies therein. A client of the repository can directly query for the existence of software package assets and/or dependent packages. The repository includes two or more repositories operating remotely to each other. The system includes one repository being co-located with the client of the other repository system.

The foregoing and other features and advantages of the invention will be apparent from the following more particular description of embodiments of the invention, as illustrated in the accompanying drawings.

### BRIEF DESCRIPTION OF THE DRAWINGS

FIG. 1 is a conceptual diagram of a multitude of software repositories accessible across several networks.

FIG. 2 is a flowchart illustrating the process used by embodiments of the present invention to detect and respond to configuration dependencies.

FIG. 3 is an exemplary rule used by the rule engine of the software repository in accordance with an embodiment of the present invention.

### DETAILED DESCRIPTION

During the execution or installation of software, it is very common for the new software system to require assistance from other pieces of software or for configuration items to have specific settings. This requirement or reliance of the software being installed or executed on other software is referred to herein as dependencies. Many different systems have been built to help automate the task of installation and configuration.

Most commonly, a program that uses another program or is dependent on it in some way would require the ability to locate the other program either at installation time or at run time. Systems which are able to install correctly but not require the existence of the dependent software can be termed loosely coupled. They are independent enough to exist without the other software program. Software which requires the other programs or configurations in order to configure itself are termed tightly coupled.

A tightly coupled program that uses Microsoft Office for its functionality, such as creating mail merges or using the Outlook calendar, would need to be able to find the Office installation in order to install itself correctly. This situation presents several different scenarios. First, it is typically desired to configure the program separately from Office, but still retain its functionality. Second, it is normally required to have installed Office before installing the dependent software program. Finally, many versions of the Office program can exist, but one must be chosen during installation.

The process of packaging and distributing applications is typically a relatively straightforward effort. Complexities arise, however, as applications and data are dependent on each other in some way. The representation and resolution of these dependencies can make the difference between a useable system and one which is only good for simple tasks. It is the goal of the present invention to ease and automate the complex task of integration.

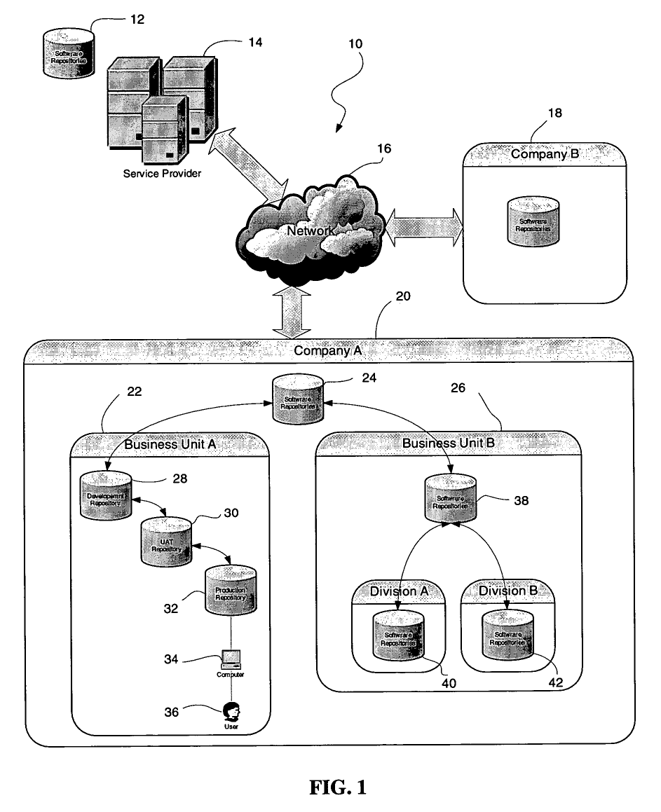

FIG. 1 illustrates a conceptual diagram of a multitude of software repositories accessible across several networks. The software repository 10 consists of one or more databases of configuration information and software assets, along with the metadata associated with embodiments of this invention. During installation, configuration, or use of a software system, a copy of the repository can be used on the installation machine 34 or a remote repository can be queried.

A software package can typically contain one or more files to be installed, executable programs, data files or other configuration elements. The form of storage of the software package within the repository may or may not be different from its form in use. The assets required to install the software package are its installation assets. They typically include the above described package elements in addition to installation programs designed to assist with the installation of the software package. Once installed, the software package will be represented by its configured assets, those parts of the software package that used to operate the software package and are configured by the installation program.

The repositories can be organized in a group or hierarchical fashion to reflect how they are used within an organization. It can be appreciated that these databases can be implemented in many ways, such as through the use of a database, XML based data files, a structured file system, or any means which is able to store the requisite information and be correctly queried and updated.

It is very common for an organization to have one or more development, packaging or testing groups with a software repository 28, additionally a second set of repositories can exist for User Acceptance Testing (UAT) 30, and finally a third set of repositories 32 exist for users and systems in live, production use of the software assets.

FIG. 1 also illustrates a simple relation of these repositories to others within the same company 26, or to other companies 18, and service providers 14. In each case, the software repositories are able to draw information and assets from each other, as well as provide assets to the target machine 34.

When a user needs to access a software application or asset, it can be drawn from this body of repositories. In a normal environment, applications are packaged within the Development Repository and promoted to the UAT Repository for end-user simulated testing. If testing is not successful, the package is returned to Development to be fixed. Otherwise, the application package is transferred to an operations team where the package is placed into a Production Repository for use directly by end users. Note that many companies or divisions do not have the resources to follow this path, and often collapse portions or all of these repositories into fewer systems, even down to one repository for all functions.

In a typical embodiment of the system, a user may be considered to have a repository 36 of their own which is a subset of all of the available repositories. Contained within their personal repository are those assets that they are currently using, or are dependent upon.

The contents of a repository, as described above, is a combination of the software assets including configuration information and a body of metadata. In a typical repository, the assets contained can be of many types including source code, object files, executables, objects such as COM or Java objects, scripts, associated data files, pointers or references to external data files or sources, or other forms of stubs and proxy objects. Commonly, a repository may exist for software developers that contains original engineering artifacts such as source code, while the repositories listed above will contain production objects such as executables and DLLs and the rest. This Engineering repository can directly feed the Development, UAT or Production repositories, or produce installation programs that are used as described above.

The metadata contained within a repository is used for several purposes. It is used to organize, index and otherwise provide structure to the material contained within. It can also be used for providing associations or dependencies among the assets stored within. Commonly, metadata is also provided to assist with the deployment process, such as information on supported platforms or scripts to perform installation tasks. An example repository such as this is the Microsoft Orca database used to contain information about an MSI or Microsoft Installer application. Additionally, other companies and technologies have existed which store this information in one or more databases. An example metadata model is that used by the DMTF CIM meta-model. However, these repositories are typically confined either to a single machine, or solely as a storage repository for program assets.

The functions of a basic repository are to store these software objects and the associated metadata, and to provide a set of functions for operating on the repository. These operations include but are not limited to methods for: adding, removing and editing assets within the repository, querying the contents of the repository, versioning, and working with the repository's metadata. In addition there are a class of functions for inter-repository communication and control for such things as asset transfer, publish-subscribe functionality, and inter-repository querying.

In the repository of the current invention there are also a set of functions for distributed querying and rules/template processing. The purpose of distributed queries is to support both workflow and multi-repository access without the need for a single master repository or index. The template engine provides a means to query the metadata at a semantic layer above the text of the content itself.

The Publishing Process

Before software reaches an end user, it will go through several transformations in a cycle of design, build, test and deploy. There are many variations on this process. One skilled in the art will appreciate that many companies use different processes to achieve this path. Additionally, this cycle can be done by one or more third parties before the software is published or made available to and end user.

Most commonly, though, software is created in two separate ways. It is created by a third party or set of third parties and distributed in some fashion to an end user or a corporate entity. In this case, the software system most often is distributed within an installation program, designed to ensure the integrity of the software, its successful implementation at a customer site, and ease that implementation for the end user. Alternately, many software programs are created by individuals at a company or home, and used solely by the members of that company. With this form of software, it is common for the system to be delivered in its original form, without an installation program. One skilled in the art will recognize that in both cases, the software must in some way be configured to operate on a destination machine or network that is most often not the same as it was developed on.

The configuration or installation process involves several steps, depending on the nature and configuration of the company performing the installation. In a large company with many users and one or more repositories, a software application will be installed offline onto a test machine to be pre-packaged into a configuration which is replicable within the company. This pre-packaging will configure target settings to reflect the most common scenarios or particulars of the company's network or processes. Once those settings are made, the information can be stored within the development or testing repositories and scheduled for end user testing. For a single user, the installation will be done directly onto their host machine and into their own personal repository. Also note that a hosting company or third party service provider will preconfigure applications in the same manner, but attempt to use settings which are broadly applicable to their entire customer base.

There exist many systems in the art for packaging and distributing applications. A detailed description of those products was done in the prior document. The basic goal of these systems is to simplify the process of performing the configuration process for many users, and provide a higher success rate for proper configuration and installation. There exist three basic forms of packaging, but one skilled in the art will appreciate that many other forms could be accommodated in the present invention.

The most simple form of packaging was described above as commonly used internally within a company, simply copying the assets of a program from one machine to another. There may exist some additional configuration, but it is done as a separate step which can be manual or scripted. In this case, there is often no care taken to ensure that the software can be removed, or that the end user environment is properly preconfigured. It is often left to the end user or some administrator to coordinate these tasks.

In order to support a larger user population, companies use the method described above where an application is pre-packaged with its common settings. In this case, a test machine will be used. In standard Electronic Software Distribution (ESD) systems, a technology is used to take a snapshot of the machine's configuration before a representative installation is performed. This is referred to herein as the preconfiguration snapshot. A second shapshot is taken after the installation. This is referred to herein as the post-configuration snapshot. The differences between these snapshots is used to create a template installation package for the company.

Newer systems have been used which allow the dynamic recording of an installation in order to create a similar package, or one used for “virtual installation.” In these cases there are often larger and/or different bodies of metadata created within the package and repository to represent the software assets.

As stated earlier, this process becomes complex when applications and data are dependent upon each other in some way. In order to resolve these dependencies, a fully automated system must detect the dependency, configure the dependency properly within the metadata, ensure that dependency is met during further installation, and track its lifecycle.

Dependency Detection

At the time a software package is installed, either on an end user machine, or on a packaging machine in a test environment, the installation program or copying process will perform many operations on the target machine to setup the assets, configuration and resources of the program. Irrespective of how these operations are recorded, a tightly coupled program will exhibit these dependencies during the installation, where a loosely coupled program will not do so.

In the case of a tightly coupled program, the installation program will fail if the program it is dependent upon is not configured on the destination machine or network. It is normally left up to the end user or packaging operator to know about this dependency or respond to the failure in the installation program. If a program requires a specific version of a database driver, it will look for that driver, or attempt to use or configure it during installation. These dependencies are often stated by the software manufacturer to reduce the number of failed installs and support problems due to these issues.

The system of the current invention simplifies and automates this problem by detecting the dependency on-the-fly. Using techniques similar to the dynamic recording system, the common operations used by installers are hooked or trapped, so they can be seen as they happen. In one embodiment of the present invention, a client agent process executes on the target machine and is responsible for these hooks. Operations consists of accesses, changes or other requests for resources of the destination machine such as Windows Registry keys, system files or other file system requests, COM object creation/query/deletion, UNIX rpm or package operations, Microsoft MSI commands, etc. . . .

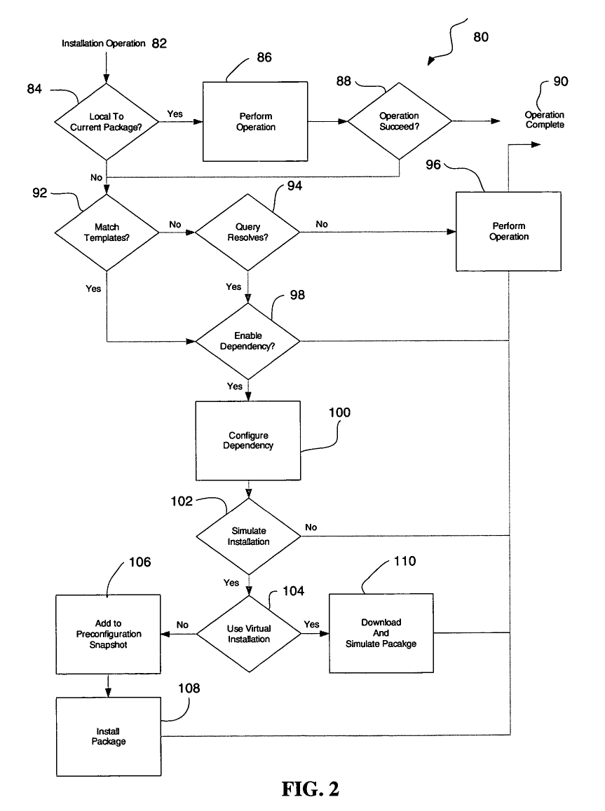

Once an operation is trapped, the system of the current invention inspects the operation per step 82 as shown in FIG. 2. If the operation is consistent with the current package per step 84, it is simply allowed to complete as normal per step 86. In a preferred embodiment, this consistency test checks if operations such as creating a file or subdirectory is within the destination machine that is particular to the program, not in a system common location, or in a location representative of another program. Alternately, if the operation per step 86 does not complete successfully (step 90) it can be reinserted in the chain to be processed as if it were not part of the current package.

The operation is next compared to the repositories or templates within the repositories per step 92. One skilled in the art will appreciate that this can be done either in order or simultaneously. In an embodiment, the operation including its parameters and context will be compared to a set of templates to identify the target of the operation. In the system of the current invention, a rules engine is used to make comparisons between the operation and templates within the repositories metadata. This template operation can be done simply on the destination machine, or in conjunction with the templates that exist within the accessible repositories.

In the example presented above, a program may use Microsoft Office to perform some of its tasks. In order to configure itself, the program may query for the presence of Office, attempt to directly configure Office, or create links within itself for integration with Office. An example operation would be the program querying the presence of the Windows Registry Key HKLM\Software\Microsoft\Office. If this key is present, then the program could further query which version is available by enumerating the subkeys of this item.

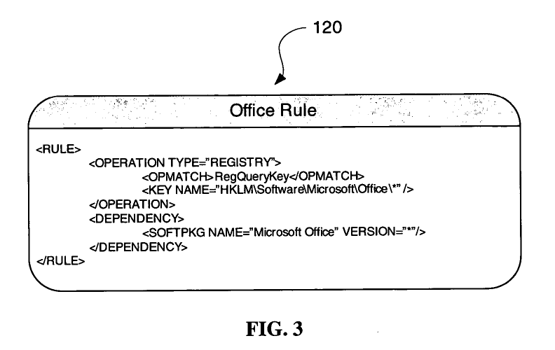

Using the templating system, metadata can be created and stored within the repositories representing that a query for this key or any of its subkeys indicates a dependency on Office. An example template is shown in FIG. 3. Note that the system of the preferred embodiment uses an XML based configuration format and allows regex and XPath style query syntax. Many other types of template and rule formats can be used as effectively within the system.

Also note that matching templates can comprise a multi-stage process. If the registry key above were queried, it would indicate a general dependency on Office. It would not indicate a version specific dependency. There can exist several related or compound templates which help further to specify the dependency. If the program does not further query the Office subkeys, a dependency on the general Office software assets could be created. This would indicate that any version of Office could be used on a target machine. If later, the Office\10.0 subkey was queried, the dependency could be restricted to the Office XP version.

Additionally, some templates that are partially matched will not create a dependency unless a further template is matched to complete a configuration. If a program were to search system common locations for MSVCRT.DLL, one could infer a dependency on that component. However, if the program installs a copy of this object within its own directory structure, the dependency is internal to the program and no external dependency exists, or alternately a dependency could be created on that specific version of the component. Thus, the templating system allows partial matching and delayed completion techniques. Most modern rule engines and other logic programs are easily able to provide this functionality.

In an alternate embodiment, the data and metadata of the repository can be queried directly. In the examplar search above for Microsoft Office, one or more packages could contain this Windows Registry key as a configuration item. The searching methodology is able to directly query the contents of this package for this element. Thus, if an installation programs searches for this configuration item, it may not find it on the destination machine, but instead within one or more packages within the repository.

Additionally, both embodiments can be combined such that if the templates do not provide resolution to the operation, then one or more repositories can be queried to satisfy the operation. To keep the example simple, we will use the same example from above and presume there is no template for the Office application, but one or more versions of Office exist in the software repositories. When the registry key is queried, the template operations will fall through. At this point local or distributed queries can be done to search for the result of this query.

In an examplar search, the registry key HKLM\Software\Microsoft\Office will be sent to each available repository as a query operation. If within a test packaging environment, a system could be configured to solely query other development repositories. If in a live environment, the end user machine should query all production repositories and configured third party or external providers. The repositories receive the query and internally perform a search for the presence of this key within any of its available packages.

Upon receipt of the results of the search, the system will configure the dependency appropriately. If the response is negative, the operation will simply fail and the installer will need to handle the failure. This is very common, as many operations are either designed to fail, or failure is a benign case. As an example, Microsoft Visio can operate independently of Microsoft Office, but will configure itself differently if Office is present. If Office is not present in any repository, then Visio will simply continue to configure itself. As an additional step, the system of the present invention can perform the operation per step 96 on the local system as a means to properly simulate the operation on the destination machine, and return the proper error codes.

If more than one response succeeds, then the system will optionally configure per step 98 the dependency (step 100) based on the rules set by the administrative policies of the system or according to the user as described below. The configuration of the dependency may include the step of publishing metadata to the repository concerning the dependency or existence of the match. An administrator may want to set preferences or hierarchies of repositories, so that an end user or package has a nearest neighbor. Note also that since repositories are able to transfer packages, the dependency information stored concerning these preferences may be altered during transfer.

Once the dependency is identified, the system of the current invention is able to respond. If the dependent package or asset is contained within a repository, the system can optionally (step 102) act to ensure that the program to be installed will do so successfully and be integrated with the dependent program if desired. The system of the preferred embodiment is able to simulate the presence (step 102) of the Office system using the virtual installation technology (step 110), install the Office system (step 108), and refuse the dependency or a combination of these techniques.

In a first method, the user performing the configuration task would a priori indicate to the system the desire to integrate the program with Microsoft Office. This can be done by providing to the user a menu of available programs within the system's repositories and allowing the user to choose one or more programs to integrate with. Using this approach, before the candidate program is installed, its prerequisites such as Microsoft Office can be setup and added to the destination machine. This will ensure that the dependent programs are part of the preconfiguration snapshot if using snapshot technology. Using the virtual installation technology, this would cause the creation of a virtual environment for Office within a context separate from the installation environment. When the installer runs, it is able to see the Microsoft Office installer, but whatever changes it makes are kept within the new packaged environment. Also, automatically a context configuration will be made that indicates the dependency of the two environments and how to enable the proper context for their operation.

In a second method, the system is able to manage the creation of program instances dynamically in response to installation program's operations. Thus, if a program were to query for the existence of Microsoft Office, the system would recognize this query from its template base or direct query and could either automatically enable the presence of Office or query the user for direction of whether to enable this integration.

If directed to or configured to automatically respond, the system can then perform an install of the dependent package (step 108). First, the system will pause the installation of the primary application. Next, if using the snapshot technology, the system will install the dependent package. If desired to package separately, the system will ensure it is added to the preconfiguration snapshot (step 106). If using the virtual installation technology, the system will download and activate the dependent package within the destination machine (step 110). This can also be done either inside of the current package or simply as a dependent context.

In the case of failure, the current installation could be terminated and removed from the system. This would return the system to its preconfiguration state. Then, the dependent package could be installed and the installation could be re-executed.

In this manner, a software application can be installed on a system with no a priori knowledge of its installation dependencies. They can be simply derived at install time from the repository. If the system is managing multiple versions of similar programs or components, it can also provide a mechanism to test for version dependency. This can be done by repeating the installation with each version of the software, testing the created software package with each version of the dependent software, or in the worst case creating a version dependency in absence of other information. In this method, all programs known by the system can be candidates for integration, thus providing comprehensive scope for testing integration points, but not needing to install all available applications on a test system.

Loosely Coupled Systems

It was noted above that loosely coupled systems do not typically exhibit dependencies at installation time. In order to enable these systems to integrate, several techniques are available both at installation time and at runtime.

During installation of the software package, the system will not normally notice any operation for a loosely coupled system. At the end of installation, the system can scan the contents of the package for indications of this integration. Often there will exist resources such as strings or other binary data within the assets or data of the program that represent the dependent items. As an example, if a program were to communicate with another through named pipes, there would exist a dependency on the named pipe operating system functions within the programs executable code, and most likely a string representing the name of the pipe, \\PIPE\ExamplePipe, somewhere in the data or the executable code.

Many loosely coupled systems use central repositories such as JNI or UDDI for discovery of bindings at runtime. These bindings can be detected a priori, if desired, and configured into the system. Again, the system would be known to use UDDI from its configured code libraries and resources could be searched to identify its target naming contexts.

Other systems use late binding to dynamically load code. System calls such as the Windows LoadLibrary can postpone the dependency on code until runtime. These calls can be identified and the system searched for strings and other indicators of what is dependent, through static or dynamic code analysis or other means.

Alternately, the dependency of the loosely coupled program can be detected at runtime. Some systems allow or require programs to be executed during packaging. Implementations which perform UAT will have a runtime context which will not be live, but will be post installation. Otherwise, the identification of the dependency can be done on the end user system.

During runtime or UAT, if the program binds to another, the dependency can be identified and created during operation of the program. Administrators may also choose to disable creation of dependencies on end user machines during runtime, allowing only dependencies during packaging or UAT.

These dependencies can take many forms including those listed above. Normal intercommunication through RPC, sockets, pipes, COM/DCOM, and other systems are simply detected. Other systems intercommunicate through modification of files, data or other assets of each other. In the same manner as shown above for detection during installation, the system can use templates and other forms of querying the repository and its metadata to identify these integrations.

Development and Administration

As described earlier, there may also exist within the system repositories for Engineering information which can feed or feed from the deployment repositories. It is becoming common practice for developers to declare the means in which their software is built, allowing metadata to be published to the Engineering repository and/or into installation programs. Similar functions can be used during development time to test dependencies of programs, author version dependencies or independencies or otherwise test various integrations of software components.

For example, if a program were built to integrate with Microsoft Office and use its Mail Merge functions, that program could be tested against one or more versions of Office as they exist in the repository. A developer could simply choose which program to install or to simulate for testing. From this testing, metadata creation could be automatically created and populated into the software repository.

For both development time and administration in a preferred embodiment, tools are provided which enable authoring of metadata into the repository and creation of templates for the templating engine. Using these tools, a software developer can build a program which declares reasonable methods of how other programs should integrate with and otherwise discover this program during installation time. Additionally, developers can provide templates for modifying those items which are externally configurable by installation programs.

In view of the wide variety of embodiments to which the principles of the present invention can be applied, it should be understood that the illustrated embodiments are exemplary only, and should not be taken as limiting the scope of the present invention. For example, the steps of the flow diagrams may be taken in sequences other than those described, and more or fewer elements may be used in the diagrams. While various elements of the embodiments have been described as being implemented in software, other embodiments in hardware of firmware implementations may alternatively be used, and vice-versa.

It will be apparent to those of ordinary skill in the art that methods involved in the System and Method for Extraction and Creation of Application Meta-Information Within a Software Application Repository may be embodied in a computer program product that includes a computer usable medium. For example, such a computer usable medium can include a readable memory device, such as, a hard drive device, a CD-ROM, a DVD-ROM, or a computer diskette, having computer readable program code segments stored thereon. The computer readable medium can also include a communications or transmission medium, such as, a bus or a communications link, either optical, wired, or wireless having program code segments carried thereon as digital or analog data signals.

Other aspects, modifications, and embodiments are within the scope of the following claims.

What is claimed is:

1. A method for automating the detection and use of dependent software packages on a target machine, the method comprising:
during the installation or execution of a first software package, detecting a dependency;
pausing the installation or execution of the software package;
configuring the dependent software package; and
continuing the installation or execution of the first software package.

2. The method of claim 1, wherein the step of detecting the dependency comprises the step of querying one or more repositories for the dependency.

3. The method of claim 2, wherein the step of detecting the dependency comprises the use of rules for template matching.

4. The method of claim 2, wherein the step of detecting the dependency comprises a query to one or more repositories for matching configuration information.

5. The method of claim 1, wherein the step of detecting the dependency comprises execution of a software operation on the target machine wherein a resultant failure indicates the need to query a repository.

6. The method of claim 1, wherein the step of detecting the dependency comprises searching a set of configured assets of the first software package.

7. The method of claim 1, wherein the step of configuring the dependent software package on the target machine comprises an installation of the dependent software package.

8. The method of claim 1, wherein information indicative of the configuration of the dependent software package is added to a preconfiguration snapshot of the target machine.

9. The method of claim 1, wherein the step of configuring the dependent software package on the target machine is performed by simulation or virtual installation.

10. The method of claim 1, wherein the step of configuring the dependent software package comprises updating one or more repositories of the configuration and dependencies of the first software package.

11. The method of claim 1, further comprising updating one or more repositories of the configuration and dependencies of the first software package.

12. A method for automating the detection and use of dependent software packages on a target machine, the method comprising:
searching a set of installation assets of a first software package for indication of dependency upon one or more other dependent software packages; and
configuring the dependent software package.

13. The method of claim 12, wherein the step of searching comprises pattern matching of information contained within the installation assets.

14. The method of claim 12, wherein the step of searching comprises using code analysis methods.

15. A system for creating a software repository comprising:
a software package asset store;
a metadata store; and
an integration engine.

16. The system of claim 15, further comprising a rule or templating engine for querying the contents of the package asset store, metadata store, and dependencies therein.

17. The system of claim 15, wherein a client of the repository can directly query for the existence of software package assets and/or dependent packages.

18. The system of claim 15, wherein the repository comprises two or more repositories operating remotely to each other.

19. The system of claim 18, wherein one repository is co-located with the client of the other repository system.
